(19) United States
(12) Patent Application Publication
(10) Pub. No.: US 2006/0137986 A1
(43) Pub. Date: Jun. 29, 2006

(54) Fluid flow controlling valve having seal with reduced leakage

(75) Inventors: James Crawford Holmes, San Carlos, CA (US); Ralph Larson, Bayport, MN (US)

Correspondence Address: Janah & Associates, P.C.;Suite 106, 650 Delancey Street, San Francisco, CA, 94107, US

(73) Assignee: Pionetics Corporation

(21) Appl. No.: 11/021,931

(22) Filed: Dec. 23, 2004

(51) Int. Cl. F16K 13/00; C25B 13/00; B04B 5/10; C10G 32/02

(52) U.S. Cl. 204/630; 204/661; 137/247.13

(57) ABSTRACT

A valve for controlling fluid flow has a housing with a plurality of ports. A movable element has a movable surface with an opening, and is capable of moving between (i) a first position in which the opening is aligned to at least one of the ports such that fluid can pass between ports, and (ii) a second position which blocks the passage of fluid between the ports. At least one rim seal encircles each of the ports, each opening, or both. A floating seal is positioned between the movable surface and the housing and is in contact with the at least one rim seal. The floating seal has a passage that aligns with the opening of the movable surface and at least one of the ports when the movable element is in the first position, and a continuous sealing surface about the passage that is sufficiently long to close off the opening of the movable surface as the movable element moves from the first position to the second position, thereby reducing leakage of fluid between the movable surface opening and the ports.

### BACKGROUND

Embodiments of the present invention relate to a valve that may be used in a fluid treatment apparatus and related methods.

Fluid treatment apparatus comprising electrochemical ion exchange cells are used to remove or replace ions in a solution stream, for example, to produce high purity water by deionization, treat waste water, or selectively substitute ions in a solution. Ion exchange materials include cation and anion exchange materials that contain replaceable ions, or which chemically react with specific ions, to exchange cations or anions, respectively, from a solution stream. A typical ion exchange cell comprises ion exchange resin beads packed into columns, though which a solution stream is passed. Ions in the solution are removed or replaced by the ion exchange material, and treated product solution, or waste water, emerges from the outlet of the column. When the ion exchange material is overwhelmed with ions from the solution, the beads are regenerated with a suitable solution. Cation exchange resins are commonly regenerated using acidic solutions or salt brine (e.g., for water softeners), and anion exchange resins are most often regenerated with basic solutions or brine.

Electrochemical ion exchange cells efficiently treat solution streams and are easier to regenerate because they do not need chemical regeneration. Electrochemical cells use a water-splitting ion exchange membrane (also known as a bipolar, double, or laminar membrane) that is positioned between two facing electrodes with a dielectric spacer between the membranes. The water splitting membranes have both cation and anion exchange layers. When a sufficiently high electric field is applied through the membrane by applying a voltage to the two electrodes, water is irreversibly dissociated or “split” into component ions H⁺ and OH⁻ at the boundary between the cation and anion exchange layers. The resultant H⁺ and OH⁻ ions migrate and diffuse through the ion exchange layers in the direction of the electrode having an opposite polarity (e.g., H⁺ ions migrate to the negative electrode). During electrical regeneration, the opposite electrical field is applied, causing H⁺ and OH⁻ ions to be formed at the membrane interface, and thereby rejecting cations and anions which are removed in a previous deionization step, thus, reforming the acid and base forms of the cation and anion exchange materials. Electrical regeneration in this way avoids the use and subsequent disposal, of hazardous chemicals used to regenerate conventional ion exchange beads, and is thus desirable.

Valves are used to control the flow of fluids during the solution treatment and cell regeneration processes performed in the electrochemical cells. The valves control and direct the flow of fluids, such as city water, well water, or even treated product, between the inlets and outlets of electrochemical cells, a drain, and a treated water outlet. For example, a rotary valve has a rotating member with a movable surface that contacts a surface of a non-rotating member to provide a fluidly sealed connection between the various inlets and outlet ports of the valve. Sealing gaskets, such as O-rings encircle each port of the valve and are maintained under compression to seal the ports.

However, conventional valves often exhibit low levels of leakage when switching flow paths from one port to another port during their operation. For example, in rotary valves, the gaskets do not always properly seal the ports in the valve, allowing low levels of fluid leakage. For example, such fluid leakage can occur during rotation of the rotary valve to connect different ports to one another, when a continuous sealing surface of the valve tilts from a plane of O-rings in the valve causing a gap to form between the continuous sealing surface and the O-rings through which fluid leaks out. The continuous sealing surface can tilt due to application of an off-axis rotational force by the drive motor or because of uneven local frictional forces. The leakage can cause cross-port and other undesirable fluid flow paths resulting in mixing of untreated or regenerated water with treated water.

Another problem with conventional O-rings arises when friction between the rotating continuous sealing surface and the O-rings causes the O-rings to prematurely fail. The friction is typically exacerbated by the elastic nature of O-rings, which are formed of elastomeric materials that typically have a high sticking coefficient. Undesirably, friction between the moving continuous sealing surface and the O-rings also requires higher torque to move the rotating continuous sealing surface requiring the use of a more expensive drive motor to drive the movable element. The frictional forces can also prematurely wear out the motor.

It is desirable to have a fluid treatment apparatus with an electrochemical cell that efficiently treats solution streams and that can be regenerated without chemicals. It is further desirable to have a valve that can effectively regulate the flow of solution into the electrochemical cells. It is further desirable for the valve to exhibit reduced cross-port leakage during operation.

### SUMMARY

A valve for a fluid treatment apparatus comprises a housing with a plurality of ports that include a first port and a second port. The valve also has a movable element with a movable surface having an opening. The movable element is capable of moving between a first position in which the opening is aligned with at least one of the first and second ports such that fluid can pass between first and second ports, and a second position in which the movable surface blocks the passage of fluid between the first and second ports. At least one rim seal encircles each of the first and second ports, each opening, or both. A floating seal lies between the movable surface of the movable element and the housing and is in contact with the at least one rim seals. The floating seal has a passage that aligns with the movable surface opening and at least one of the first and second ports when the movable element is in the first position, and a continuous sealing surface about the passage that is sufficiently long to close off the opening of the movable surface as the movable element moves from the first position to the second position, thereby reducing leakage of fluid between the opening and the first and second ports.

A fluid treatment apparatus that uses the valve comprises a pair of electrochemical cells, each cell having electrodes and a water-splitting ion exchange membrane between the electrodes. A power supply supplies a current to the electrodes. A valve controller is capable of operating the motor to move the movable element between the first and second positions.

A method of regulating a fluid flow path between first and second ports with reduced leakage of fluid comprises (a) aligning an opening to a first position in which the opening is aligned to at least one of the first and second ports to allow fluid to pass between the first and second ports, (b) moving the opening from the first position to a second position in which the first and second ports are blocked to prevent fluid from passing between the first and second ports; and during (b), covering the opening with a continuous sealing surface while moving the opening from the first position to the second position to reduce leakage of fluid between the opening and the first and second ports.

In another embodiment, the valve comprises a housing having a base with first, second and third ports; and a cover fitting over the base, the cover comprising a chamber with a fourth port. A movable element comprises a movable surface having an opening and a channel capable of connecting one or more of the first, second, third or fourth ports. The movable element is capable of moving between (i) a first position in which the opening of the movable element is aligned to at least one of the first, second, or third ports such that fluid can pass between at least two of the first, second and third ports via the channel, and (ii) a second position which blocks the passage of fluid between the first, second and third ports. At least one rim seal encircles each of the first through fourth ports, the opening, or both. A floating seal is between the movable surface of the movable element and the housing and is in contact with the at least one rim seals. The floating seal comprises a passage that aligns with the movable surface opening and any of the first, second or third ports, when the movable element is in the first position; and a continuous sealing surface about the passage that is sufficiently long to close off the opening of the moveable surface as the movable element moves from the first position to the second position thereby reducing leakage of fluid between the opening and the first, second and third ports.

In another embodiment, a rotary valve for controlling fluid flow comprises a housing comprising a plurality of ports that include a first port and a second port, and at least one rim seal encircling each of the first and second ports. A rotor comprising a movable surface having an opening therein, is capable of moving between (i) a first position in which the opening of the movable surface is aligned to at least one of the first or second ports such that fluid can pass between the first and second ports, and (ii) a second position which blocks the passage of fluid between the first and second ports. A floating seal lies between the movable surface of the rotor and the at least one rim seals. The floating seal comprises a passage that aligns with the opening of the movable surface and at least one of the first and second ports when the rotor is in the first position, and a continuous sealing surface about the passage that is sufficiently long to close off the opening of the movable surface as the rotor rotates from the first position to the second position thereby reducing leakage of fluid between the opening and the first and second ports. A rotary actuator is provided to rotate the rotor between the first position and the second position.

In a further embodiment, a sliding valve for a fluid treatment apparatus comprises a housing comprising a plurality of ports that include a first port and a second port, and with at least one rim seal encircling each port. A sliding member comprising a movable surface having an opening, that is capable of moving between (i) a first position in which the opening of the movable surface is aligned to at least one of the first and second ports such that fluid can pass between the first and second ports, and (ii) a second position which blocks the passage of fluid between the first and second ports. A floating seal lies between the sliding member movable surface and the at least one rim seals. The floating seal comprises a passage that aligns with the opening of the movable surface and at least one of the first and second ports when the sliding member is in the first position, and a continuous sealing surface about the passage that is sufficiently long to close off the opening of the movable surface as the sliding member slides from the first position to the second position thereby reducing leakage of fluid between the opening and the first and second ports. A linear actuator is provided to slide the sliding member between the first and second positions.

In an additional embodiment, a cylinder valve for controlling fluid flow comprises a housing comprising a plurality of ports that include a first port and a second port. A cylindrical rotating member has a sidewall that has a movable surface and an opening therein and at least one rim seal encircling the opening. The cylindrical rotating member is capable of moving between (i) a first position in which the opening of the movable surface is aligned to at least one of the first and second ports such that fluid can pass between the first and second ports, and (ii) a second position which blocks the passage of fluid between the first and second ports. A floating seal lies between the housing and the at least one rim seals. The floating seal comprises a passage that aligns with the opening of the movable surface and at least one of the first and second ports when the cylindrical rotating member is in the first position, and a continuous sealing surface about the passage that is sufficiently long to close off the opening of the movable surface as the cylindrical rotating member rotates from the first position to the second position thereby reducing leakage of fluid between the opening and the first and second ports. A rotary actuator is provided to rotate the cylindrical rotating member between the first and second positions.

### DRAWINGS

These features, aspects and advantages of the present invention will become better understood with regard to the following description, appended claims, and accompanying drawings, which illustrate examples of the invention. However, it is to be understood that each of the features can be used in the invention in general, not merely in the context of the particular drawings, and the invention includes any combination of these features, where:

FIG. 1 is a schematic block diagram of a fluid treatment apparatus according to an embodiment of the present invention;

FIG. 2 is a sectional side view of a valve suitable for regulating the flow of fluid through the fluid treatment apparatus shown in FIG.1;

FIG. 3 is a top view of the base of the valve of FIG. 2;

FIG. 4 is a sectional side view of the cover of the valve of FIG. 2;

FIG. 5 is a sectional side view of a movable element of the valve of FIG. 2;

FIG. 6 is a top view of a floating seal of the valve of FIG. 2;

FIGS. 7A, 7B, 7C shows the movable surface of the movable element in various positions;

FIG. 8 is a sectional side view of another embodiment of a valve comprising a flat housing with a sliding member and floating seal;

FIG. 9A is a sectional side view of another embodiment of a valve comprising a cylindrical housing with a cylindrical rotating member and a floating seal;

FIG. 9B is a top plan view of the valve of FIG. 9A showing channels in the cylindrical rotating member;

FIG. 10 is a flowchart illustrating a method of controlling fluid flow between at least two ports in a valve while minimizing fluid leakage between the ports;

FIG. 11 is a schematic view of an ion controlling apparatus having an electrochemical cell with a membrane cartridge that is capable of providing a selected ion concentration in a solution stream; and

FIG. 12 is a schematic sectional top view of an electrochemical cell comprising a cartridge having membranes with integral spacers that are spirally wound around a core tube.

### DESCRIPTION

Embodiments of the present invention are capable of treating an influent solution to extract, replace, or add ions to the solution, to generate an effluent solution having desired ion concentration levels. Exemplary embodiments of the fluid treatment apparatus are provided to illustrate the invention and should not be used to limit the scope of the invention. For example, the fluid treatment apparatus can include apparatus other than electrochemical ion exchange apparatus, or alternative cell arrangements and configurations as would be apparent to those of ordinary skill in the art, which are within the scope of the present invention. Also, in addition to the treatment of water, which is described as an exemplary embodiment herein, the fluid treatment apparatus can be used to treat other fluids, such as solvent or oil based fluids, chemical slurries, and waste water, as would be apparent to those of ordinary skill in the art.

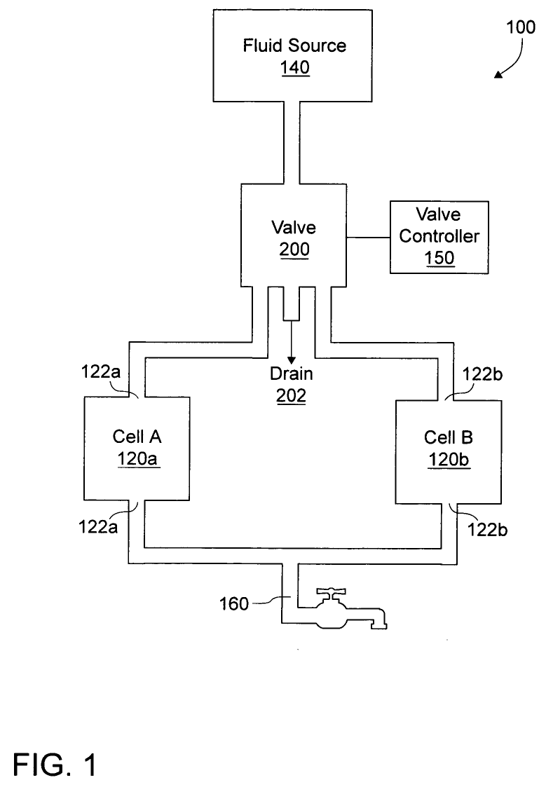

An exemplary embodiment of a fluid treatment apparatus 100 is shown in FIG. 1. Generally, the fluid treatment apparatus 100 comprises a fluid source 140, one or more fluid treatment cells 120a, 120b for treating a solution from the fluid source 140, and an outlet 160 for distributing the treated fluid product. The arrows generally depict the fluid flow path through the apparatus 100. For example, the fluid source 140 can be a city water supply or water from a well, which is to be purified by one or both of the treatment cells 120a, 120b and the resultant purified water provided to a drinker via a faucet or other suitable outlet 160.

The apparatus 100 includes a valve 200 between the fluid source 140 and the treatment cells 120a, 120b to regulate the flow of fluid through the apparatus 100. For example, the valve 200 can regulate the flow of fluid from the source 140 to the treatment cells 120a, 120b, from the treatment cells 120a, 120b to a drain 202 in the valve 200, or from one treatment cell 120a to another 120b or vice versa. The valve 100 can also be used to pass the fluid to other fluid treatment apparatus as would be apparent to one of ordinary skill in the art.

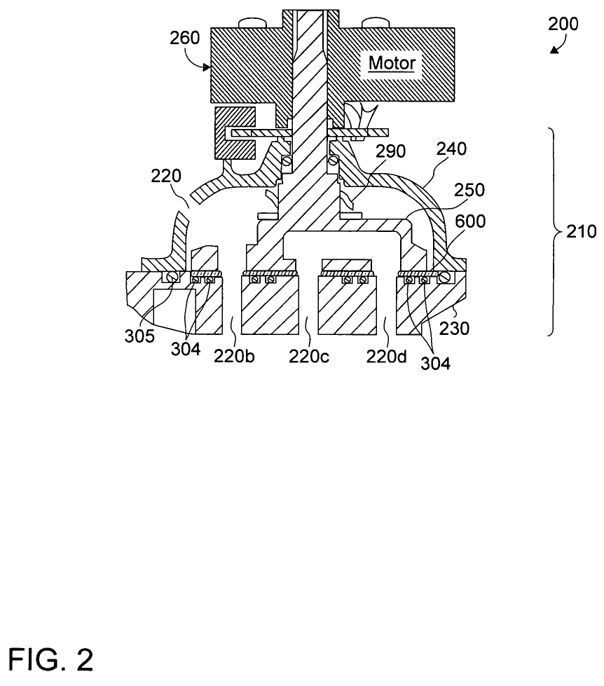

An embodiment of a valve 200 that is suitable for regulating the flow of fluid through the fluid treatment apparatus 100 is shown in FIG. 2. Generally, the valve 200 comprises an enclosed housing 210 that receives and holds fluid without leakage. The housing 210 has a plurality of ports 220 through which fluid can enter and leave the valve 200. While an exemplary embodiment of the housing 210 having a particular shape and arrangement of ports 220 is shown to illustrate the invention, the housing 210 may have other shapes and structures and fewer or additional ports 220, depending on the configuration of the valve 200.

In the embodiment shown, the housing 210 comprises an enclosed structure comprising a unitary structure such as a hollow tube (not shown), or a compound structure such as a base 230 coupled to a cover 240 (as shown). The housing 210 is typically fabricated by injection molding a polymer, such as NORYL™, from General Electric, Pittsfield, Mass., which is modified polyphenylene oxide and polyphenylene ether. However, the housing 210 can also be made from other materials, such as stainless steel, aluminum or copper. Typically, the housing 210 is made from materials that are resistant to corrosion or erosion by the fluid passing through the valve 200. For example, for fluids comprising acidic or basic solutions, a polymeric material may be used. For the treatment of water, e.g. to provide drinking water, the housing 210 can be made from conventional plastics, such as those approved by the National Sanitation Foundation (www.NSF.org), such as for example epoxy, acrylonitrile butadiene styrene (ABS), polyvinyl chloride (PVC), ethylene propylene terpolymer, fiberglass reinforced polyester and polyethylene. Depending on the material used to fabricate the housing 210, reinforcement ridges, spines, and/or cylinders around ports can also be provided in the structural design and fabrication process to strengthen the housing 210.

A movable element 250 is disposed within the housing 210 and extends out from the cover 240. The movable element 250 is coupled to a motor 260 that moves the movable element 250 in the housing 210. In one embodiment, the motor 260 rotates the movable element 250; however, the motor 260 can also slide the movable element longitudinally, vertically, transversely or in other direction depending on the shape and configuration of the valve 200. Furthermore, the movable element 250 can comprise different embodiments, such as a rotor, sliding member, or cylindrical member as described below, and other shapes as would be apparent to one of ordinary skill in the art.

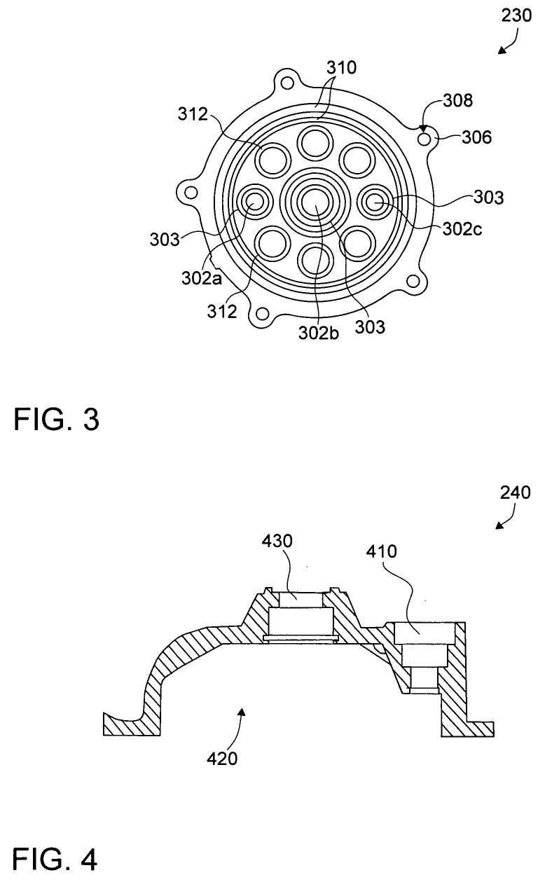

A version of the valve 200 comprising a housing 210 with a base 230 and cover 240, and a movable element 250 within the housing 210, is described with reference to FIGS. 2 to 6. The base 230 comprises a plurality of base ports 302a-302c, with at least one circular groove 303 encircling each base port 302a-302c, as shown in FIG. 3. The circular groove 303 is capable of receiving a rim seal 304 (shown in FIG. 2) that surrounds the base port 302a-302c. The rim seals 304 can be O-rings that are sized to fit into the corresponding circular grooves 303. Each base port 302a can have more than one concentric circular groove 303 to allow the placement of multiple rim seals 304 around the port 302a. The rim seals 304 are made from a flexible material that compresses under an applied compressive stress to form a fluid tight seal that serves as the front line of leakage prevention. In one embodiment, the rim seals 304 are made from an elastomeric material, such as for example, rubber, soft polymer, or elastomer. However, the rim seals can also be made from other materials, such as silicone rubber or polytetrafluoroethylene.

The base 230 can also include supplemental circular grooves 312 into which supplemental seals (not shown) can also be inserted. The supplemental circular grooves 312 can be located on either side of the base ports 302a-302c to provide additional seals at both sides of the base ports 302a-302c. In addition, the base 230 also has one or more peripheral grooves 310 extending around its periphery to receive a sealing gasket 305 (shown in FIG. 2) that properly encloses and seals the housing 210. The base 230 can have an outwardly extending circumferential lip 306 with holes 308 to allow attachment of the base 230 to the cover 240.

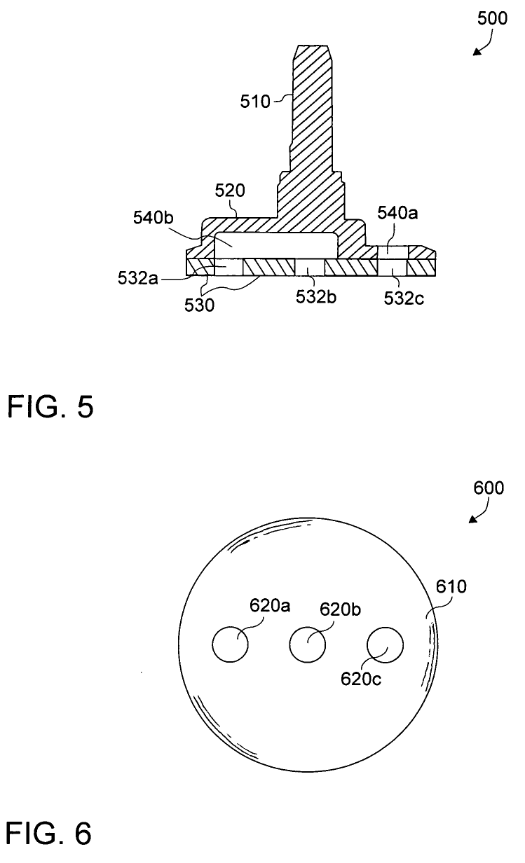

A cover 240, as shown in the FIG. 4, is fitted over the base 230 as shown in FIG. 2. The cover 240 can have at least one inlet port 410 for receiving fluid from the fluid source 140 as shown in FIG. 1. The cover 240 is configured to form a chamber 420 that stores the fluid received from the source 140 via the inlet port 410. The cover 240 also can include a shaft opening 430 through which the movable element 250 extends. When the source 140 provides fluid that is under pressure, such as from a city water supply, the water in the chamber 420 is also under the same external pressure.

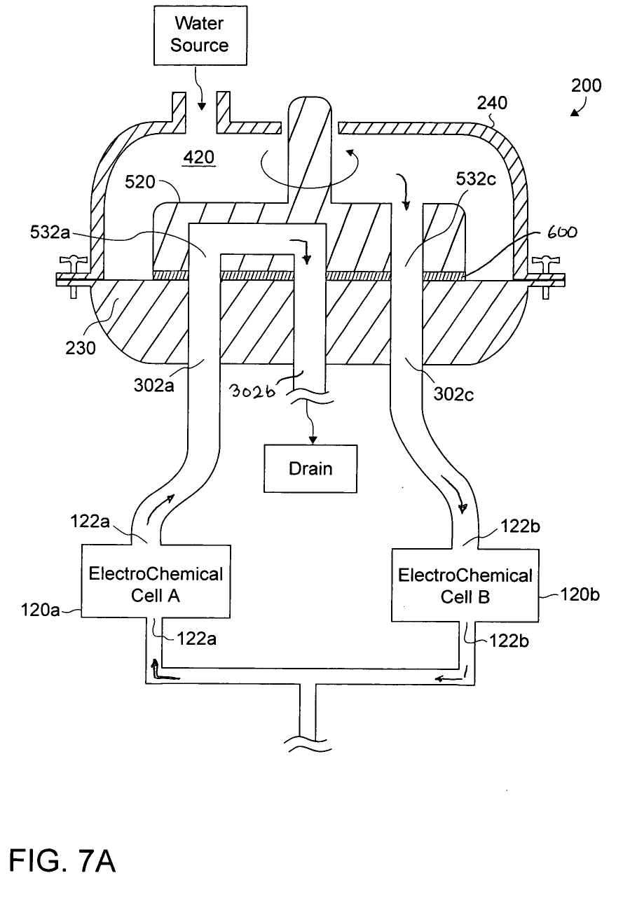

In one embodiment, the movable element 250 is a rotor 500 that includes a shaft 510 connected to a plate 520 having the movable surface 530, as shown in FIG. 5. The rotor 500 is within the housing 210 (FIG. 2) such that the plate 520 is disposed adjacent to the base 230 and the shaft 510 extends out through the cover 240. The plate 520 is maintained under a compressive force, and has a movable surface 530 which is flat and with one or more openings 532a-532c therethrough. The openings 532a-532c are located about the circumference and/or center of the movable surface 530 such that the openings 532a-532c can be aligned with at least one base port 302a-302c when the shaft 510 and plate 520 are rotated. In one embodiment, at least one of the openings 532c extends through the plate 520 to form a channel 540a. Although not shown, the movable surface 530 can be adapted to house seals encircling each of the openings 532a-532c.

The rotor 500 may also comprise an internal channel 540b capabie of connecting two or more openings 532a-532c in the movable surface 530. In one embodiment, the movable surface 530 comprises at least three openings 532a-532c, two of which are connected via the internal channel 540b and one of which forms the channel 540a. A conical section, which is simply provided for facilitating injection molding of the assembly 500 and not for structural purposes, extends out from the flat movable surface 530 and is connected to the shaft 510. The internal channel 540b resides in a hump projecting out from the conical section.

At a minimum, the plate 520 is capable of moving between a first position and a second position. In the first position, at least one of the openings 532a in the movable surface 530 is aligned over at least one of the plurality of base ports 302a such that fluid can pass through the at least one aligned base port 302a into the opening 532a. For example, in one embodiment, the cover 240 (FIG. 4) has an inlet port 410 for receiving water from a water source 140—such as a city water supply, well water, or bottled water—and the movable surface 530 (FIG. 5) has an opening 532c that forms the channel 540a that may be aligned with a base port 302c (FIG. 3) in the base 230. In this embodiment, when the opening 532c and channel 540a in the rotor is aligned with the base port 302c in the base 230, water flows through the inlet port 410 into the chamber 420 of the cover plate 240, and out through the aligned channel 540a and base port 302c.

In the second position, the plate 520 blocks the passage of fluid through any of the base ports 302a-302c. Thus, by moving the plate 520, e.g., between the first and second positions, fluid flow from the chamber 420 to the appropriate base port 302c is regulated. Nevertheless, as mentioned above, as the plate 520 moves, fluid leakage from the chamber 420 to the base ports 302a-302c is common and undesirable.

To solve this problem, the valve 200 includes a floating seal 600 between the movable element 250 (such as the rotor 500) and the base 230, as shown in FIG.2. In one embodiment, the floating seal 600 has a first movable surface that interfaces with the movable surface 530 of the movable element 250 on one movable surface and on an opposite movable surface interfaces with the rim seals 304 in the circular grooves 303 around the base ports 302a-302c in the base 230 (FIG. 3). Thus, when a compressive force is applied to the movable element 250, a tight leak-free barrier between the movable element 250 and the floating seal 600 that prevents leakage of fluid between the chamber 420 and base ports 302a-302c is formed.

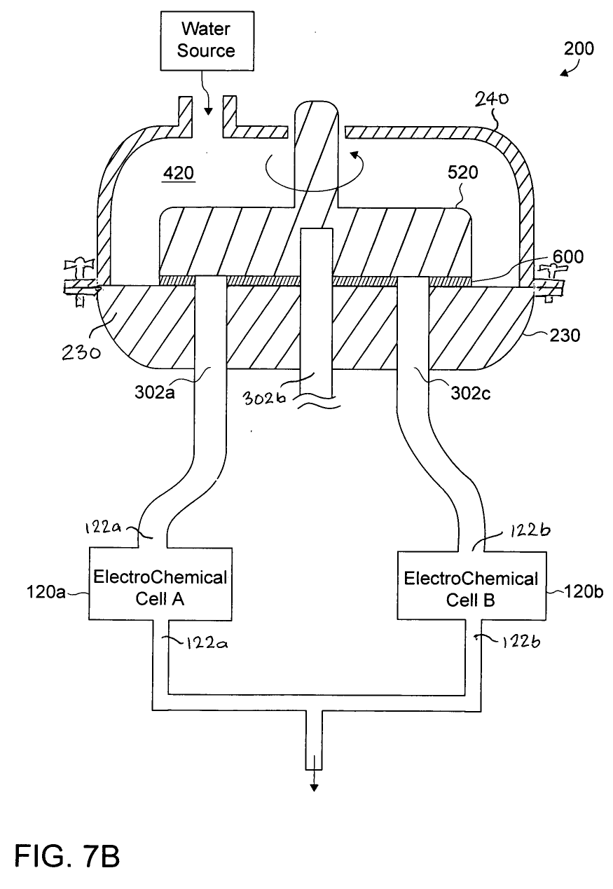

FIG. 6 is a top view of the floating seal 600 that is shaped to correspond to the shape of the movable element 250 and the base 230. In the version illustrated, the floating seal 600 is utilized with the rotor of FIG. 5. The floating seal 600 has at least one passage 620a -620c that can be aligned with the openings 532a-532c and at least one of the base ports 302a-302c when the plate 520 is in the first position, i.e., when at least one of the openings 532c in the movable surface 530 is aligned over at least one of the plurality of base ports 302c such that fluid can pass through the opening 532c and into the aligned base port 302c.

Around or about each passage 620a -620c is a continuous sealing surface 610 that is sufficiently long to maintain a seal between the base ports 302a-302c while the plate 520 is moved from the first position to the second position. For example, in the embodiment in which an opening 532c in the movable surface 530 is aligned with a base port 302c in the base 230, e.g., in the aligned first position, the passage 620c in the floating seal 600 allows fluid to flow from the chamber 420 through the opening 532c into the base port 302c. However, when the opening 532c is not aligned with the base port 302c, i.e., the plate 520 is in the second position, the opening 532c in the movable surface 530 is positioned over the continuous sealing surface 610 of the floating seal 600. The continuous sealing surface 610 should be sufficiently long along a linear or curved pathway between the base ports 302a-302c. The curved pathway is needed when the plate 520 moves along a curved path between the ports 302a-302c, thereby covering an area having both a width and length. By sufficiently long it is meant at least the distance between the ports 302a-302c, which distance depends upon the design of the valve 200. For example, a suitable distance can be from about 2 mm to about 100 mm. Generally, this distance is at least the diameter of one of the ports 302a, but it could be less.

The compressive force applied to the rotor 500 that presses it against the floating seal 600, as well as the rim seals 304 on the other side of the floating seal 600, forms a tight leak-free barrier at the opening 532a-532c of the movable surface 530, which prevents leakage of fluid from the chamber 420 into the base port 302a-302c during movement of the plate 520. Moreover, because the movable surface 530 moves against the floating seal 600, as opposed to the rim seals 304, the force required to move the plate 520 is reduced.

The floating seal 600 is not attached to either of the adjacent base 230 or movable surface 530. The floating seal 600 can be completely free, that is totally unattached, or can be held in place by cutouts that are sized to fit around the rim seals 304 of the base ports 302a-302c in the base 230. The floating seal 600 may also be partially attached, or anchored, to the adjacent base 230 or movable surface 530 so that it moves a little but not the entire range of motion of the movable surface 530. The floating seal 600 is advantageous because it allows the movable element 250 to freely move above the seal 600 without being impeded by the rim seals 304 underlying the floating seal. The rim seals 304 are typically made from a softer and more elastomeric material than the floating seal 600, and thus, they can impeded the free movement of the floating seal 600 because such seals are more ‘sticky” than the floating seal 600.

The floating seal 600 should be sufficiently resilient that it does not flex excessively under the compressive force applied by the movable surface 530 or the force applied by the fluid pressure of fluid from the fluid source that is contained in the chamber 420. On the opposing side of the movable surface 530, the floating seal 600 is supported by the rim seals 304 around each of the base ports 302a-302c of the base 230. The rim seals 304 are distributed in a symmetric arrangement to provide adequate support and balance thereby preventing tilting of the floating seal 600. Moreover, supplemental seals provided in the supplemental circular grooves 312 in the base 230 can also serve to support and balance the floating seal 600 together with the movable element.

Because the floating seal 600 contacts the movable surface 530 while the plate 520 is being moved from one position to another, the floating seal 600 should have a low dynamic coefficient of friction to minimize wear of the movable surface 530 as well as to minimize rotational resistance. The floating seal 600 should also be sufficiently strong to prevent or reduce tearing of the floating seal material during movement of the movable surface 530 against the floating seal 600.

A suitable material for the floating seal 600 has a resilience, as for example, measured by its elastic modulus, of at least about 700 MPa. For example, a suitable floating seal 600 can be made from materials such as tetrafluoroethylene, for example Teflon®, available from Dupont de Nemours Company Wilmington, Del. Teflon is a polytetrafluoroethylene (PTFE) and can be any of three similar compounds: perfluoroalkoxy polymer resin (PFA), fluorinated ethylene propylene copolymer (FEP), and the copolymer of ethylene and tetrafluoroethylene (ETFE). PTFE typically has an elastic modulus measured according to ASTM test D-882, of 760 to 1240 MPa depending on the direction of the measurement. Teflon has a dynamic coefficient of friction μₖ of less than about 0.5, and even less than about 0.1. PTFE also has good propagating tear strength, which reduces the likelihood of tearing of the seal 600 during use. PTFE has a propagating tear strength measured according to ASTM D-1922 of about 0.9 to 1.8 Newtons. PTFE is also virtually inert to all chemicals and solvents except molten alkali metals, fluorine at elevated temperatures, and certain complex halogenated compounds such as chlorine trifluoride at elevated temperatures and pressures.

The floating seal 600 can also comprise a fluoropolymer resin, such as T² Films of Tefzel® (ETFE). ETFE has an elastic modulus measured according to ASTM test D-882, of 4,900 MPa (700,000 psi). ETFE also has a dynamic coefficient of friction of less than about 0.5, and even less than about 0.2, and a propagating tear strength of from about 2.3 to about 10.5 N. While exemplary materials for the floating seal 600 are described herein, it should be noted that the floating seal 600 can be made of other materials as would be apparent to one of ordinary skill in the art.

Referring to FIGS. 2 and 5, a spring 290 that fits around the shaft 510 maintains an initial compressive force on the movable surface 530, which in turn presses against the floating seal 600. One end of the spring 290 rests on a ridge of a cylindrical platform that extends around the shaft 510 and is attached to the plate 520. The other end of the spring 290 sits on a circular ledge of a cavity of the center of the cover 240. The spring 290 is compressed during assembly of the shaft 510 in the valve and exerts an outward force against the cylindrical platform of the shaft 510 thereby forcing the plate 520 against the floating seal 600, which in turn presses against the underlying rim seals 304 mounted on the base 230. The resultant compressive stress on the plate 520 maintains a good seal between the movable surface 530, the floating seal 600 and the rim seals 304 around each port 302a-302c. The spring 290 can be made from metal or any other material that can retain its shape under compressive stress, for example, a phosphorous bronze alloy.

During rotation of the plate 520 from a position to another position, one or more of the openings 532a-532c in the plate 520 moves across the continuous movable surface of the floating seal 600. As a result, the water from the water source held in the chamber 420 passes through the openings 532a-532c in the plate 520 which are now positioned over the floating seal 600 to exert a pressure on the floating seal 600. This applied water pressure forces the floating seal 600 against the rim seals 304 to effectively seal the ports 302a-302c and prevent water leakage during movement of the plate 520. The countervailing force on the other side of the floating seal 600 is atmospheric pressure which is less than the water pressure, thereby providing a net pressure that forces the floating seal 600 against the rim seals 304. Furthermore, when the water source provides water at a higher pressure which would normally increase the likelihood of leakage from the valve, the water pressure in the chamber 420 also increases to apply a higher pressure on the floating seal 600 and thereby continue to maintain a water-tight seal. The increase in applied pressure on the floating seal 600 with increased water source pressure provides the unexpected benefit of maintaining a good, water-tight seal during rotation of the plate 520 across the floating seal 600, even when the water source pressure suddenly increases.

As is shown in FIG. 2, a motor 260 is connected to the movable element 250 via a gear assembly. The motor 260 can be a conventional DC motor that is geared down and controlled to provide rapid step movements of the movable element 250. A suitable DC motor can be a rotary actuator which rotates a movable element comprising the rotor 500, or a linear actuator which slides the movable element 250. A gear assembly comprises a set of gears that provide a suitable gearing ratio can also be used.

A valve controller 150 is provided to operate the valve 200, as shown in FIG. 1 for example, to send signals to the motor 260 to control movement of the movable element 250 from a first position to second or other positions. A suitable valve controller 150 comprises an application specific integrated circuit having a programmable logic circuit. The valve controller 150 can also be a CPU chip coupled to a memory and with suitable hardware interface boards to allow communication and signal exchanges between the valve 200, motor 260 and other system components, for example, the electrochemical cells 102 a,b.

To illustrate how the valve 200 may be used, refer again to FIG. 1. Here, the fluid treatment apparatus 100 is capable of treating water from a source 140, such as the city water supply. The treatment cells 120a, 120b are a pair of electrochemical cells, cells A and B. Each electrochemical cell 120a has two orifices 122a for receiving or expelling fluids, depending on the operational mode of the cell 120a. For example, if the cell 120a is operating in a water treatment mode, a first orifice 122a is utilized to receive city water 140 and a second orifice 122a is utilized to pass treated solution out of the cell 120a. One of the two orifices 122a of each electrochemical cell 120a is connected to a valve 200, while the second orifice 122a is connected to an outlet manifold 160 that supplies treated water to a tank or tap controllable by a user.

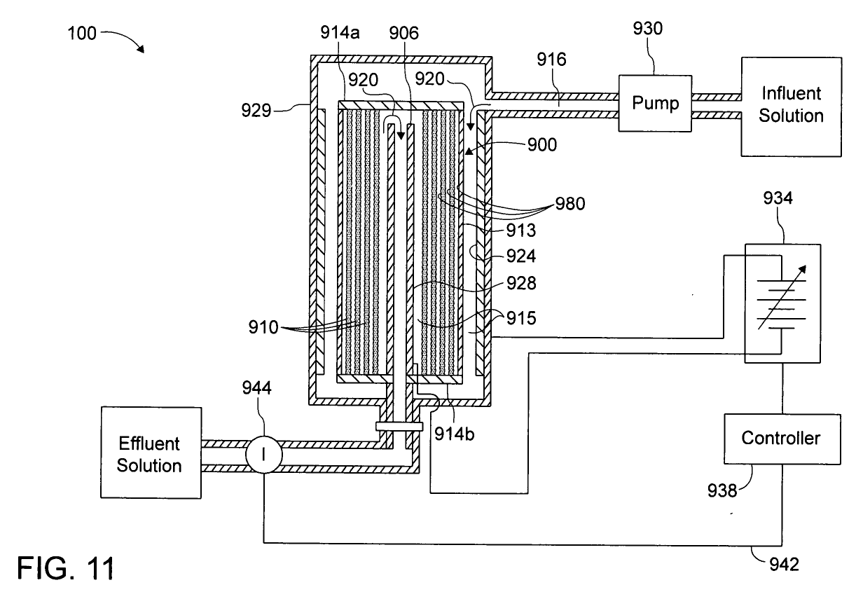

FIG. 11 presents an embodiment of an ion controlling apparatus 100 to provide a selected ion concentration in a product stream using an electrochemical cell 120. The cell 120 includes an enclosure 929 enclosing at least two electrodes 924, 928, a plurality of water-splitting ion exchange membranes 910 between the electrodes 924, 928, and a power supply 934 to supply a current to the electrodes 924, 928, as for example, described in commonly assigned U.S. Pat. No. 5,788,812 (Nyberg) and application Ser. No. 10/900,256 (Nyberg) both of which are incorporated herein by reference in their entireties. A pump 930 can be used to pump the solution stream through the cell 120, such as a peristaltic pump or water pressure from the city water supply in combination with a flow control device.

The electrodes 924, 928 are fabricated from electrically conductive materials, such as metals which are preferably resistant to corrosion in the low or high pH chemical environments created during positive and negative polarization of the electrodes during operation of the cell 120. Suitable electrodes 924, 928 can be fabricated from corrosion-resistant materials such as titanium or niobium, and can have an outer coating of a noble metal, such as platinum. The shape of the electrodes 924, 928 depends upon the design of the electrochemical cell 120 and the conductivity of the solution stream 920 flowing through the cell 120. Suitable electrodes 924, 928 comprise a wire arranged to provide a uniform voltage across the cartridge. However, the electrodes 924, 928 can also have other shapes, such as cylindrical, plate, spiral, disc, or even conical shapes.

The power supply 934 powers the first and second electrodes 924, 928. The power supply 934 can be capable of maintaining the first and second electrodes 924, 928 at a single voltage, or a plurality of voltage levels during an ion exchange stage. The power supply 934 can be a variable direct voltage supply or a phase control voltage supply as described in commonly assigned U.S. patent application Ser. No. 10/637,186, filed on Aug. 8, 2003, entitled “Selectable Ion Concentration with Electrolytic Ion Exchange,” which is incorporated herein by reference in its entirety.

In one version, the power supply 934 comprises a variable voltage supply that provides a time modulated or pulsed direct current (DC) voltage having a single polarity that remains either positive or negative, during an ion removal step, or during an ion rejection step. In contrast, a non-DC voltage such as an alternating current (AC) supply voltage, has a time-averaged AC voltage that would be approximately zero. Employing one polarity over the course of either an ion removal (deionization) or ion rejection (regeneration) step in the operation of the electrolytic ion exchange cell 120 allows ions in the solution 920 being treated to travel in a single direction toward or away from one of the electrodes 924, 928, thereby providing a net mass transport of ions either into or out of the water-splitting membranes 910. The magnitude of the average DC voltage is obtained by mathematically integrating the voltage over a time period and then dividing the integral by the time period. The polarity of the integration tells whether one is in ion removal or rejection mode, and the magnitude of this calculation is proportional to the electrical energy made available for ion removal or rejection.

An output sensor 944 can also be positioned in the solution stream exterior to the outlet 918 (as shown) or interior to the housing 929 to determine the ion concentration of the treated solution. The sensor 944 can measure, for example, concentration, species, or ratio of concentrations of ions in the treated solution. In one version, the sensor 944 is a conductivity sensor, which is useful to determine and control total dissolved solids (TDS) concentration in the treated effluent solution 920. Alternatively, the sensor 944 can be a sensor specific to a particular ionic species, for example nitrate, arsenic or lead. The ion specific sensor can be, for example, ISE (ion selective electrode). Generally, it is preferred to place the sensor 944 as far upstream as possible to obtain the earliest measurement. The earlier the sensor measurement can be determined in this embodiment, the more precisely can be controlled the ion concentration of the treated solution.

A controller 938 can operate the power supply 934 in response to an ion concentration signal received from the sensor 944 via a closed control feedback loop 942. The controller 938 is any device capable of receiving, processing and forwarding the sensor signal to the power supply 934 in order to adjust the voltage level, such as for example, a general purpose computer having a CPU, memory, input devices and display—or even a hardware controller with suitable circuitry. In one version, the controller sends a control signal to the power supply 934 to control the voltage output to the electrodes 924, 928.

The controller 938 comprises electronic circuitry and program code to receive, evaluate, and send signals. For example, the controller can comprise (i) a programmable integrated circuit chip or a central processing unit (CPU), (ii) random access memory and stored memory, (iii) peripheral input and output devices such as keyboards and displays, and (iv) hardware interface boards comprising analog, digital input and output boards, and communication boards. The controller can also comprise program code instructions stored in the memory that is capable of controlling and monitoring the electrochemical cell 120, sensor 944, and power supply 934.

The program code may be written in any conventional computer programming language. Suitable program code is entered into single or multiple files using a conventional text editor and stored or embodied in the memory. If the entered code text is in a high level language, the code is compiled, and the resultant compiler code is then linked with an object code of pre-compiled library routines. To execute the linked, compiled object code, the user invokes the object code, causing the CPU to read and execute the code to perform the tasks identified in the program.

The water-splitting ion exchange membranes 910 have adjacent cation and anion exchange layers and can be textured. Porous dielectric spacer layers can also be used to separate the textured membranes 910. An electrochemical cell 120 having the textured membranes 910, and optional integral spacers 980 overlying the membrane 910, provides better control of the ion composition of the treated solution stream, in comparison with conventional electrochemical cells. Moreover, the ion concentration in the treated solution stream can be further improved by closed a loop control system.

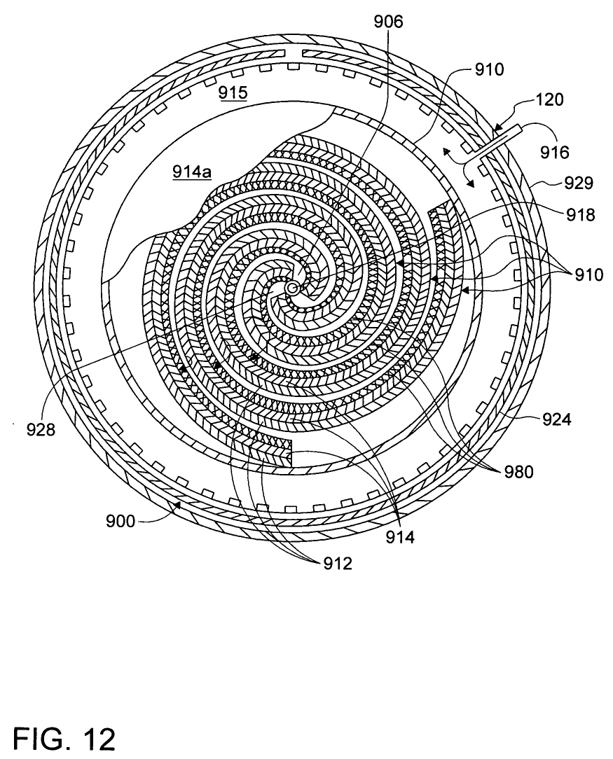

In one embodiment, the cartridge 900 comprises several membranes 910 with integral spacers 980 that are spirally wound around a core tube 906, which is typically cylindrical, as shown in FIG. 12. The spirally wound membranes 910 can be enclosed by an outer sleeve 913, and sealed at both ends with two end caps 914a, b. When the membrane 910 does not have an integral spacer 980, the cartridge 900 is fabricated with a spacer sleeve (not shown) between each membrane 910, as for example, described in commonly assigned U.S. patent application Ser. No. 10/637,186, filed on Aug. 8, 2003, entitled “Selectable Ion Concentration with Electrolytic Ion Exchange,” which is incorporated herein by reference in its entirety. The surfaces of the outer sleeve 913, core tube 906 and end caps 914a, b direct the solution stream 920 through a solution passageway 915 that passes across the exposed surfaces 924 of the textured membrane 910 in traveling from the inlet 916 to the outlet 918 of the cell 120.

The cartridge 900 may be designed for a variety of flow patterns, for example end-to-end flow (parallel to the cored tube 906) or inner-to-outer flow (radial flow to or from the core tube 906). Each end cap 914a,b of the cartridge 900 can be a flat plate mounted on either end of the core tube 906. The core tube 906, outer sleeve 913 and end-caps 914a,b are designed to provide a solution passageway 915 that provides the desired flow pattern across substantially the entire membrane surface. For example, for the solution stream 920 to flow radially to or from the core tube 906, across both the inner and outer surfaces of each textured membrane 910, the end-caps 914a,b seal the ends of the spirally wound membrane to prevent solution from by-passing the membrane surface on its way from inlet to outlet. The textured membranes 910 can also be arranged in the cartridge 900 to provide a solution passageway 915 that forms a unitary and contiguous solution channel that flows past both the anion and cation exchange layers 912, 914 of each membrane 910. Preferably, the unitary channel is connected throughout in an unbroken sequence extending continuously from the inlet 916 to the outlet 918, and flowing past each anion and cation exchange layers 912, 914, respectively, of the water-splitting membranes 910. Thus the unitary and contiguous channel's perimeter comprises at least a portion of all the cation and anion exchange layers 912, 914, of the membranes 910 within the cartridge 900.

The membranes 910 can be spiral wrapped with the integral spacers 980 formed on the inner surface of a cation exchange layer 914 separating it from the adjacent anion exchange layer 912, and providing the solution passageway 915 therebetween. In this one embodiment, three membranes 910 are spiral wrapped to form a parallel flow arrangement, which means that the solution can flow from inlet to outlet in three equivalent passageways between membrane layers. For any flow pattern, for example parallel or radial relative to the core tube 906, one or more membranes 910 can be wrapped in a parallel arrangement to vary the pressure drop across the cartridge 900, the number of membranes 910 that are being wrapped in a parallel flow arrangement selected to provide the desired pressure drop through the cell 120. While the membranes 910 are generally tightly wound against each other, for pictorial clarity, the membranes 910 are shown loosely wound with spaces between them. In this version, the wrapped cartridge 900 is absent electrodes, which are positioned outside the cartridge in the cell.

The cartridge 900 is positioned within a housing 929 of the electrochemical cell 120, which has the solution inlet 916 for introducing an influent solution stream 920 into the cell and the solution outlet 918 that provides an effluent solution stream. An outer electrode 924 and a central electrode 928 are positioned in the housing 929 such that the cation exchange layers 914 of the membranes 910 face the first electrode 924, and the anion exchange layers 912 of the membranes 910 face the second electrode 928.

Referring back to FIG. 1 and FIG. 11, each cell 120a, 120b operates in one of two modes: (i) a treatment or water deionization mode, and (ii) a regeneration mode. During treatment or water ionization, the electric field applied through the membrane 910 by applying a voltage to the two electrodes 924, 928, causes the water to be irreversibly dissociated or “split” into component ions H+ and OH− at the boundary between the cation and anion exchange layers of each membrane 910. During electrical regeneration, the opposite electrical field is applied, causing H+ and OH− ions to be formed at the membrane interface, and thereby rejecting cations and anions which are removed in a previous deionization step, thus, reforming the acid and base forms of the cation and anion exchange materials. Optimally, while electrochemical cell A 120a is being used to treat the city water supply 140 flowing through the cell 120a, electrochemical cell B 120b is being regenerated. The valve 200 directs the passage of untreated water 140 to either cell A (120a) or cell B (120b). Thus, cell A (120a) can be operating in the water treatment mode, while cell B (120b) is operating simultaneously in the regeneration mode.

Here, the valve 200 is configured similar to the valve illustrated in FIGS. 2-6. In particular, the base 230 (FIG. 3) of the valve 200 comprises three base ports 302a-302c, namely, a first port 302a, a second port 302b, and a third port 302c, which are arranged in a row with the second port 302b at the center of the base 230, and the other ports 302a, 302c on either side of the second port 302b. The first port 302a is connected to an orifice 122a of cell A (120a), the second or middle port 302b is connected to a drain 202, and the third port 302c is connected to an orifice 122b of the cell B (120b).

The cover 240 (FIG. 4) of the valve 200 comprises a fourth (inlet) port 410 that is connected to the city water supply 140. The plate 520 (FIG. 5) has a movable surface 530 with three openings 532a-532c. The first 532a and second 532b openings are interconnected by the internal channel 540b in the body of the plate 520. The third opening 532c extends through the plate 520 to form the channel 540a, thereby allowing passage of fluid through the plate 520 and out of the chamber 420 of the cover 240.

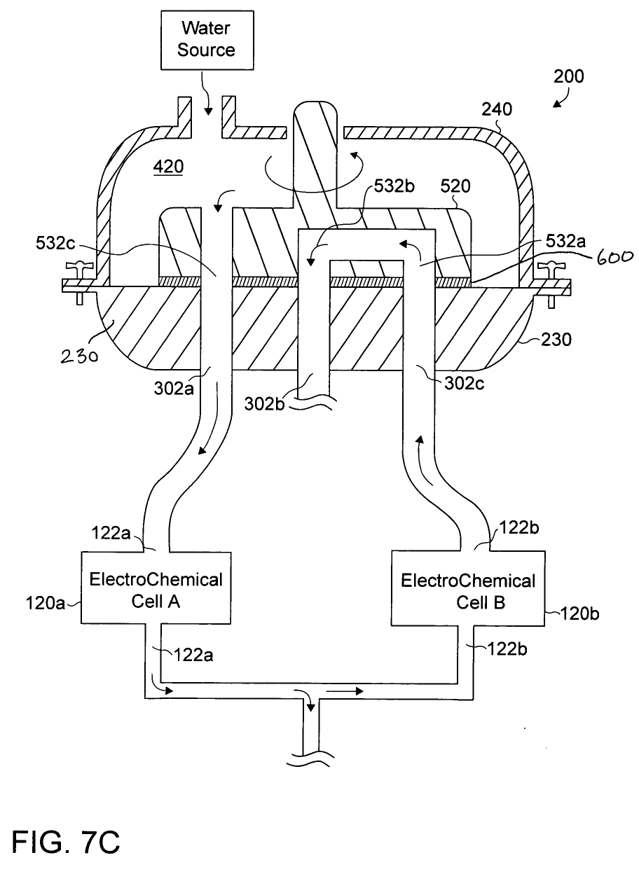

In operation, the valve 200 directs the flow of water 140 to either of the cells 120a, 120b and also receives regenerated waste water from either of the cells 120a, 120b and expels such waste water through the drain 202. The valve 200 performs this by moving the movable element 250 between at least two positions. For example, where the movable element 250 is a rotor 500, the rotor 500 is rotated to regulate flow. FIG. 7A shows the plate 520 in a first position in which the city water supply 140 is passed through the chamber 420 in the valve cover 240, into the third opening 532c on the plate 520, and then into Cell B (120b) via an orifice 122b.

Simultaneously, Cell A (120a) is operating in the regeneration mode. Here, the treated water from the Cell B (120b) is passed through one of the two orifices 122a of Cell A (120a) and the treated water is used to remove ions displaced from the ion exchange membrane during regeneration of Cell A (120a). The regeneration waste water from Cell A (120a) is expelled from the other of the two orifices 122a, passes into the first port 302a of the base 230, through the first opening 532a of the movable surface 530, then through the internal channel 540b in the plate 520, and out of the second or middle opening 532b of the movable surface 530 and into the second port 302b of the base 230 to an external city drain.

FIG. 7B shows the plate 520 rotated to a second position in which neither of the first 532a or third openings 532c is aligned with either of the first 302a or third 302c base ports. Accordingly, the plate 520 prevents fluid flow to and from either cell A (120a) or cell B (120b) via the first 302a and third 302b base ports, respectively. Notably, the floating seal 600 forms a tight seal with the movable surface 530 such that when the plate 520 is moved to and from the second position, fluid leakage is minimized.

FIG. 7C shows the plate 520 in another rotated position in which Cell A (120a) is used to treat the water supply 140 while the Cell B (120b) is being regenerated. Here, the third opening 532c is now aligned over the first base port 302a and the first opening 532a is aligned over the third base port 302c. The city water supply 140 passes through the chamber 420 in the valve cover 240, into the third opening 532c and through the first base port 302a, and then into cell A (120a) for treatment.

Simultaneously, cell B (120b) is operating in the regeneration mode. Here, the treated water from the cell A (120a) passes through one of the two orifices 122b of cell B (120b) and the treated water is used to remove ions displaced from the ion exchange membrane during regeneration of cell B (120b). The regeneration waste water from cell B (120b) is expelled from the other of the two orifices 122b, passes into the third port 302c of the base 230, through the first opening 532a of the movable surface 530, then through the internal channel 540b in the plate 520, and out of the second or middle opening 532b of the movable surface 530 and into the second port 302b of the base 230 to an external city drain.

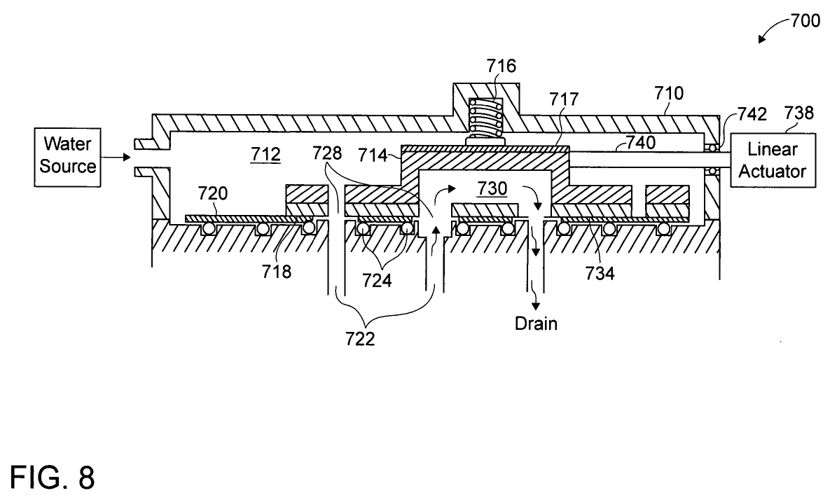

An alternate embodiment, comprising a sliding valve 700 is shown in FIG. 8. The sliding valve 700 comprising a flat shaped housing 710 with a chamber 712 and containing a sliding member 714 that is linearly actuated. The housing 710 has a number of ports 722 that are each encircled by a rim seal 724. The sliding member 714 is maintained at a compressive force by a spring 716 that slides along the back surface 717 of the sliding member. The spring 716 can be a leaf or coil spring and the back surface 717 can be made of a low friction material such as Teflon®. The sliding member 714 also comprises a movable surface 718 with one or more openings 728. The sliding member 714 is capable of sliding between a first position in which the opening 728 is aligned to at least one of the ports 722 such that fluid can pass between ports 722, and a second position which blocks the passage of fluid between the ports 722.

A floating seal 720 lies between the movable surface 718 of the sliding member 714 and the rim seals 724 of the ports 722 in the housing 710. The material of the housing, sliding member and floating seal is as previously described. The floating seal 720 comprises at least one passage 730 that aligns with an opening 728 in the movable surface 718 and at least one of the ports 722 when the sliding member 714 is in the first position. The floating seal 720 also has a continuous sealing surface 734 about the passages 730 that is sufficiently long to maintain a seal between two or more ports 722 while the sliding member 714 slides from the first position to the second position thereby reducing leakage of fluid from the ports 722.

In this version, a linear actuator 738 is provided to drive a shaft 740 connected to the sliding member 714 to slide the member 714 between the first and second positions. The linear actuator 738 can be, for example, a solenoid, fluid driven piston, electric motor driven screw or other electromagnetic linear actuation devices. A bearing 742 can also be provide to support the shaft 740. Operation of the valve 700 is the same as the valve 200, except that the sliding member 714 moves linearly across the ports 722 to connect one or more of the ports.

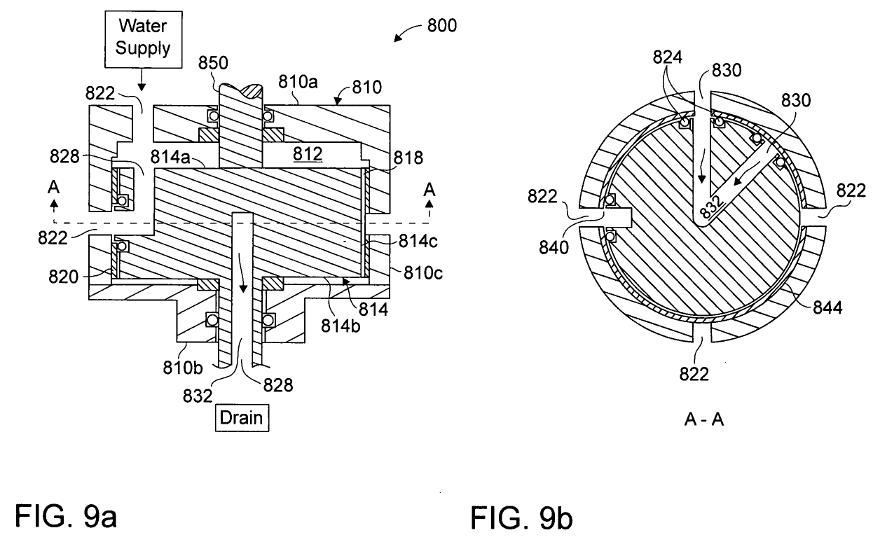

In yet another embodiment, a cylindrical valve 800 is shown in FIGS. 9A and 9B. The cylindrical valve 800 comprises a cylindrical housing 810 that forms a chamber 812, and that contains a cylindrical rotating member 814 that rotates within the cylindrical housing 810. The cylindrical rotating member 814 fits snuggly within the cylindrical housing 810 with just enough room between the rotating member 814 and the housing 810 to allow the rotating member 814 to rotate without touching the housing 810.

The housing 810 has upper 810a and lower 810b surfaces and a cylindrical sidewall 810c. Each comprise one or more ports 822. The cylindrical rotating member 814 also has upper 814a and lower 814b surfaces in which one or more openings 828 are disposed, and a cylindrical sidewall 814c, which comprises a movable surface 818 with one or more sidewall openings 830. Each sidewall opening 830 is encircled by a rim seal 824. The cylindrical rotating member 814 is capable of moving between a first position in which at least one sidewall opening 830 is aligned to at least one of the ports 822 such that fluid can pass between ports 822, and a second position which blocks the passage of fluid between the ports 822.

A floating seal 820 makes contact with the rim seals 824 and lies between the movable surface 818 of the sidewall 814c of the cylindrical rotating member 814 and the sidewall 810c of the housing 810. The material of the housing, rotating member and floating seal is as previously described. The floating seal 820 comprises at least one passage 840 that aligns with a sidewall opening 830 in the movable surface 818 and at least one of the ports 822 when the rotating member 814 is in the first position. The floating seal 820 also has a continuous sealing surface 844 about the passage 840 that is sufficiently long to maintain a seal between two or more ports 822 while the rotating member 814 rotates from the first position to the second position thereby reducing leakage of fluid from the ports 822.

In this version, a rotary motor (not shown) is provided to rotate a shaft 850 connected to the cylindrical rotating member 814 to rotate the member 814 between the first and second positions. The rotary motor can be that previously described.

Unlike the valves 200, 700 described above, the cylinder valve 800 does not require a mechanism, e.g., a spring, for pressing the movable surface 818 against the floating seal 820. Because the cylindrical rotating member 814 fits snuggly within the housing 810, a tight seal between the rim seals 824 in the sidewall 814c of the rotating member 814 and the floating seal 820 is formed inherent. Accordingly, the extra cost of procuring and installing a spring is avoided.

In operation, untreated water flows into the chamber 812 via a port 822 in the upper surface 810a of the housing 810 and flows to a treatment cell (not shown) via a sidewall opening 830 and a port 822 in the sidewall 810c of the housing 810. Simultaneously or subsequently, waste water from a treatment cell flows into a port 822 in the sidewall 810c of the housing 810 and through a sidewall opening 830 which connects to a channel 832 leading to drain via an opening 828 in the lower surface 814b of the cylindrical rotating member 814.

In this version, the ports 822 and sidewall openings 830 leading to treatment cells are disposed in the sidewalls 810c, 814c of the cylindrical housing 810 and cylindrical rotating member 814. Because the sidewalls 810c, 814c offer ample surface area for ports 822 and openings 830, several sets of electrochemical cell pairs can be serviced simultaneously by a single cylinder valve 800.

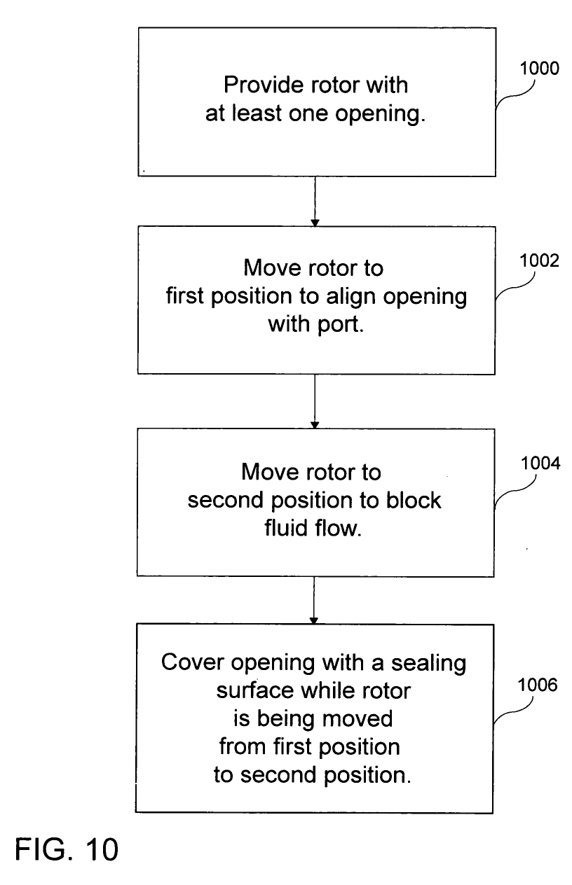

FIG. 10 is a flowchart illustrating a method by which fluid flow is controlled between at least two ports in a valve while minimizing fluid leakage between the at least two ports. The process begins by providing a movable element in the valve that has a movable surface of the movable element that includes at least one opening (step 1000). Next, the movable element is moved to a first position such that the at least one opening is aligned with at least one of the ports (step 1002). In this first position, fluid is allowed to flow between the ports. The movable element is then moved to a second position such that the movable element prevents fluid flow between the ports (step 1004). While the movable element is being moved from the first position to the second position, the opening is covered by a continuous sealing surface such that leakage from the ports is minimized (step 1006).

The present invention has been described with reference to certain preferred versions thereof; however, other versions are possible. For example, the floating seal can be used in other types of applications, as would be apparent to one of ordinary skill. For example, the floating seal can be used in any apparatus that utilizes sliding relative movable surfaces to meter and control compressible and incompressible fluids. Other configurations of the valve can also be used. For example, although O-rings are provided as the rim seals, other types of gasket shapes can be used effectively and/or a single molded gasket can be used to simplify product assembly. Therefore, the spirit and scope of the appended claims should not be limited to the description of the preferred versions contained herein.

1. A valve for controlling fluid flow comprising:
(a) a housing comprising a first port and a second port;
(b) a movable element comprising a movable surface having an opening, the movable element capable of moving between (i) a first position in which the opening is aligned to at least one of the first or second ports such that fluid can pass between ports, and (ii) a second position which blocks the passage of fluid between the first and second ports;
(c) at least one rim seal encircling each of the first and second ports of the housing, each opening in the movable surface, or both; and
(d) a floating seal between the movable surface of the movable element and the housing, the floating seal being in contact with the at least one rim seal, the floating seal comprising:
(i) a passage that aligns with the movable surface opening and at least one of the first and second ports when the movable element is in the first position; and
(ii) a continuous sealing surface about the passage that is sufficiently long to close off the opening of the movable surface as the movable element moves from the first position to the second position thereby reducing leakage of fluid between the movable surface opening and the first and second ports.

2. A valve according to claim 1 wherein the floating seal comprises an elastic modulus of at least about 700 MPa.

3. A valve according to claim 2 wherein the floating seal comprises a dynamic coefficient of friction of less than about 0.5.

4. A valve according to claim 3 wherein the floating seal comprises polytetrafluroethylene.

5. A valve according to claim 1 wherein the at least one rim seal comprises a silicone polymer, elastomer or polytetrafluroethylone.

6. A valve according to claim 1 wherein the housing comprises:
(1) a base with first, second, and third ports; and
(2) a cover fitting over the base, the cover comprising a chamber with a fourth port.

7. A valve according to claim 6 wherein the movable element comprises a channel capable of connecting one or more of the first, second and third ports.

8. A valve according to claim 1 wherein the movable element comprises a rotor.

9. A valve according to claim 1 wherein the movable element comprises a sliding member.

10. A valve according to claim 1 wherein the movable element comprises a cylindrical rotating member.

11. A valve according to daim 1 and further comprising a motor connected to the movable element.

12. A valve according to claim 11 wherein the motor comprises a rotary actuator or a linear actuator.

13. A valve according to claim 11 wherein the motor comprises a linear actuator.

14. A fluid treatment apparatus comprising the valve of claim 11, and further comprising:
(1) a pair of electrochemical cells, each cell having electrodes and a water-splitting ion exchange membrane between the electrodes;
(2) a power supply to supply a current to the electrodes; and
(3) a valve controller capable of operating the motor to move the movable element between the first and second positions.

15. A valve for controlling fluid flow comprising:
(a) a housing comprising (i) a base with first, second and third ports; and (ii) a cover fitting over the base, the cover comprising a chamber with a fourth port;
(b) a movable element comprising a movable surface having an opening and a channel capable of connecting one or more of the first, second, third or fourth ports, the movable element capable of moving between (i) a first position in which the opening is aligned to at least one of the first, second, or third ports such that fluid can pass between at least two of the first, second, and third ports, via the channel, and (ii) a second position which blocks the passage of fluid between the first, second and third ports;
(c) at least one rim seal encircling each of the first, second and third ports of the housing, each opening in the movable surface, or both; and
(d) a floating seal between the movable surface of the movable element and the housing, the floating seal being in contact with the at least one rim seal, the floating seal comprising:
(i) a passage that aligns with the movable surface opening and any of the first, second or third ports, when the movable element is in the first position; and
(ii) a continuous sealing surface about the passage that is sufficiently long to close off the opening of the movable surface as the movable element moves from the first position to the second position thereby reducing leakage of fluid between the opening of the movable surface and the first, second or third ports.

16. A valve according to claim 15 wherein the floating seal comprises an elastic modulus of at least about 700 MPa and a dynamic coefficient of friction of less than about 0.5.

17. A valve according to claim 15 wherein the floating seal comprises polytetrafluroethylene.

18. A valve according to claim 15 and further comprising a motor connected to the movable element.

19. A fluid treatment apparatus comprising the valve of claim 15, and further comprising:
(1) a pair of electrochemical cells, each cell having electrodes and a water-splitting ion exchange membrane between the electrodes;
(2) a power supply to supply a current to the electrodes; and
(3) a valve controller capable of operating the motor to move the movable element between the first and second positions.

20. A method of controlling a fluid flow path between first and second ports comprising:
(a) aligning an opening to a first position in which the opening is aligned to at least one of the first and second ports to allow fluid to pass between the ports;
(b) moving the opening from the first position to a second position in which the ports are blocked to prevent fluid from passing between the ports; and
(c) during (b), covering the opening with a continuous sealing surface while moving the opening from the first position to the second position to reduce leakage of fluid between the opening and the first and second ports.

21. A method according to claim 20 wherein (c) comprises moving the opening onto the continuous sealing surface during movement of the opening from the first to the second position.

22. A method according to claim 20 comprising rotating the opening onto the continuous sealing surface.

23. A method according to claim 20 comprising sliding the opening onto the continuous sealing surface.

24. A method according to claim 20 comprising rotating a movable element having the opening, while maintaining the continuous sealing surface fixed to the movable element.

25. A method according to claim 20 further comprising maintaining at least one rim seal around each of the first and second ports, the opening, or both, and contacting the continuous sealing surface with the at least one rim seal.

26. A fluid treatment apparatus comprising:
(a) a pair of electrochemical cells, each cell comprising:
(i) a housing comprising a pair of electrodes;
(ii) a water-splitting ion exchange membrane between the electrodes; and
(iii) a fluid inlet and a fluid outlet;
(b) a power supply to supply a current to the electrodes;
(c) a valve comprising:
(i) a housing comprising (1) a base with first, second, and third ports; and (2) a cover fitting over the base, the cover comprising a chamber with a fourth port;
(ii) a movable element comprising a movable surface having an opening and a channel capable of connecting one or more of the first, second, third or fourth ports, the movable element capable of moving between (i) a first position in which the opening is aligned to at least one of the first, second, or third ports such that fluid can pass between at least two of the first, second and third ports via the channel, and (ii) a second position which blocks the passage of fluid between the first, second and third ports;
(iii) at least one rim seal encircling each of the first, second and third ports of the housing, each opening in the movable surface, or both;
(iv) a motor connected to the movable element; and
(v) a floating seal between the movable surface of the movable element and the housing, the floating seal being in contact with the at least one rim seal, the floating seal comprising:
(1) a passage that aligns with the movable surface opening and any of the first, second or third ports, when the movable element is in the first position; and
(2) a continuous sealing surface about the passage that is sufficiently long to close off the opening of the movable surface as the movable element moves from the first position to the second position thereby reducing leakage of fluid between the opening and the first, second or third ports; and
(d) a valve controller capable of operating the motor to move the movable element from the first position to the second position.

27. A fluid treatment apparatus according to claim 26 wherein the floating seal comprises an elastic modulus of at least about 700 MPa and a dynamic coefficient of friction of less than about 0.5.

28. A fluid treatment apparatus according to claim 26 wherein the floating seal comprises polytetrafluroethylene.

29. A rotary valve for controlling fluid flow comprising:
(a) a housing comprising a first port and a second port, and at least one rim seal encircling each of the first and second ports;
(b) a rotor comprising a movable surface having an opening, the rotor capable of moving between (i) a first position in which the opening of the movable surface is aligned to at least one of the first or second ports such that fluid can pass between the first and second ports, and (ii) a second position which blocks the passage of fluid between the first and second ports;
(c) a floating seal between the movable surface of the rotor and the at least one rim seals, the floating seal comprising:
(i) a passage that aligns with the movable surface opening and at least one of the first and second ports when the rotor is in the first position; and
(ii) a continuous sealing surface about the passage that is sufficiently long to close off the opening of the movable surface as the rotor moves from the first position to the second position thereby reducing leakage of fluid between the opening of the movable surface and the first and second ports; and
(d) a rotary actuator to rotate the rotor between the first position and the second position.

30. A rotary valve according to claim 29 wherein the floating seal comprises an elastic modulus of at least about 700 MPa and a dynamic coefficient of friction of less than about 0.5.

31. A rotary valve according to claim 29 wherein the floating seal comprises polytetrafluroethylene.

32. A rotary valve according to claim 29 wherein the housing further comprises a third port and a fourth port, and the rotor comprises a channel capable of connecting one or more of the first to fourth ports.

33. A fluid treatment apparatus comprising the rotary valve of claim 29, and further comprising:
(1) a pair of electrochemical cells, each cell having electrodes and a water-splitting ion exchange membrane between the electrodes;
(2) a power supply to supply a current to the electrodes; and
(3) a valve controller capable of operating the rotary actuator to move the rotor from between the first and second positions.

34. A sliding valve for controlling fluid flow comprising:
(a) a housing comprising a first port and a second port, and at least one rim seal encircling each of the first and second ports;
(b) a sliding member comprising a movable surface having an opening, the sliding member capable of sliding between (i) a first position in which the opening of the movable surface is aligned to at least one of the first or second ports such that fluid can pass between the first and second ports, and (ii) a second position which blocks the passage of fluid between the opening of the movable surface and the first and second ports;
(c) a floating seal between the movable surface of the sliding member and the at least one rim seals, the floating seal comprising:
(i) a passage that aligns with the sliding member opening and at least one of the first and second ports when the sliding member is in the first position; and
(ii) a continuous sealing surface about the passage that is sufficiently long to close off the opening of the movable surface as the sliding member slides from the first position to the second position thereby reducing leakage of fluid between the opening of the movable surface and first and second ports; and
(d) a linear actuator to slide the sliding member between the first and second positions.

35. A sliding valve according to claim 34 wherein the floating seal comprises an elastic modulus of at least about 700 MPa and a dynamic coefficient of friction of less than about 0.5.

36. A sliding valve according to claim 34 wherein the floating seal comprises polytetrafluroethylene.

37. A sliding valve according to claim 34 wherein the housing further comprises a third port and a fourth port, and the sliding member comprises a channel capable of connecting one or more of the first to fourth ports.

38. A sliding valve according to claim 34 wherein the linear actuator comprises an electromagnetic linear actuation device.

39. A sliding valve according to claim 34 wherein the linear actuator comprises a solenoid, fluid driven piston or electric motor driven screw.

40. A fluid treatment apparatus comprising the sliding valve of claim 34, and further comprising:
(1) a pair of electrochemical cells, each cell having electrodes and a water-splitting ion exchange membrane between the electrodes,
(2) a power supply to supply a current to the electrodes; and
(3) a valve controller capable of operating the linear actuator to move the sliding member between the first and second positions.

41. A cylinder valve for controlling fluid flow comprising:
(a) a cylindrical housing comprising a first port and a second port;
(b) a cylindrical rotating member comprising a sidewall having a movable surface and an opening and at least one rim seal encircling the opening, the cylindrical rotating member capable of rotating between (i) a first position in which the opening of the movable surface is aligned to the first or second ports such that fluid can pass between ports, and (ii) a second position which blocks the passage of fluid between the first and second ports;
(d) a floating seal between the cylindrical housing and the at least one rim seal, the floating seal comprising:
(i) a passage that aligns with the movable surface opening and at least one of the first and second ports when the cylindrical rotating member is in the first position; and
(ii) a continuous sealing surface about the passage that is sufficiently long to close off the opening of the movable surface as the cylindrical rotating member rotates from the first position to the second position thereby reducing leakage of fluid between the movable surface opening and the first and second ports; and
(e) a rotary actuator to rotate the cylindrical rotating member between the first and second positions.

42. A cylinder valve according to claim 41 wherein the floating seal comprises an elastic modulus of at least about 700 MPa and a dynamic coefficient of friction of less than about 0.5.

43. A cylinder valve according to claim 41 wherein the floating seal comprises polytetrafluroethylene.

44. A cylinder valve according to claim 41 wherein the housing further comprises a third port and a fourth port, and the cylindrical rotating member comprises a channel capable of connecting one or more of the first to fourth ports.

45. A fluid treatment apparatus comprising the cylinder valve of claim 41, and further comprising:
(1) a pair of electrochemical cells, each cell having electrodes and a water-splitting ion exchange membrane between the electrodes;
(2) a power supply to supply a current to the electrodes; and
(3) a valve controller capable of operating the rotary actuator to move the cylindrical rotating member between the first and second positions.

46. A fluid treatment apparatus comprising:
(a) an electrochemical cell comprising first and second orifices to receive or expel a fluid, a pair of electrodes, and at least one water-splitting ion exchange membrane between the electrodes;
(b) a power supply to supply a current to the electrodes of the cell;
(c) a valve to control fluid flow through the cell; and
(d) a controller to operate the power supply and valve to:
(i) in a deionization mode, flow fluid into the first orifice of the cell while maintaining a current between the electrodes in the cell to form a treated fluid which is passed out of the second orifice of the cell; and
(ii) in a regeneration mode, flow fluid into the second orifice of the cell while maintaining a current between the electrodes of the cell to regenerate the cell.

47. An apparatus according to claim 46 wherein the first orifice is adapted to receive a fluid comprising a solution that includes water.

48. An apparatus according to daim 46 wherein the valve comprises (i) a plurality of ports which are connected to the orifices of the cell, (ii) a movable element capable of moving between positions in which the ports are aligned to, or blocked from, one another, and (iii) a motor to move the movable element.

49. A fluid treatment apparatus comprising:
(a) first and second electrochemical cells, each electrochemical cell comprising a pair of orifices to receive or expel a fluid, a pair of electrodes, and at least one water-splitting ion exchange membrane between the electrodes;
(b) a power supply to supply a current to the electrodes of the first and second cells;
(c) a valve to control fluid flow through the first and second cells; and
(d) a controller to operate the power supply and valve to:
(i) deionize fluid in the first cell by maintaining a current between the electrodes of the first cell while flowing fluid into the first cell to form treated fluid which is released at an orifice of the first cell, and
(ii) regenerate the second cell by flowing the treated fluid from the orifice of the first cell into an orifice of the second cell while maintaining a current between the electrodes of the second cell to regenerate the second cell.

50. An apparatus according to claim 49 wherein in use, each cell comprises a first orifice to receive fluid for deionization and a second orifice to release the deionized fluid, and in (d) (i) the controller operates the valve to flow fluid into a first orifice of the first cell to form treated fluid which is passed out of a second orifice of the first cell, and in (d) (ii) the controller operates the valve to flow the treated fluid into a second orifice of the second cell to form regenerated waste fluid which is passed out from the first orifice of the second cell to drain.

51. An apparatus according to claim 50 wherein the first orifice is adapted to receive a fluid comprising a solution that indudes water.

52. An apparatus according to claim 49 wherein the valve comprises (i) a plurality of ports which are connected to the orifices of the first and second cells, (ii) a movable element capable of moving between positions in which the ports are aligned to, or blocked from, one another, and (iii) a motor to move the movable element.

53. A fluid treatment apparatus comprising:
(a) first and second electrochemical cells, each electrochemical cell comprising a first orifice to receive a fluid for deionization and a second orifice to expel the deionized fluid, a pair of electrodes, and at least one water-splitting ion exchange membrane between the electrodes;
(b) a power supply to supply a current to the electrodes of the first and second cells;
(c) a valve to control fluid flow through the first and second orifices of the first and second cells; and
(d) a controller to operate the power supply and valve to:
(i) deionize fluid in the first cell by maintaining a current between the electrodes of the first cell while flowing fluid into the first orifice of the first cell to form deionized fluid which is released at the second orifice of the first cell, and
(ii) regenerate the second cell by flowing the deionized fluid from the second orifice of the first cell into the second orifice of the second cell while maintaining a current between the electrodes of the second cell to regenerate the second cell.

54. A fluid treatment method conducted in an electrochemical cell having first and second orifices, a pair of electrodes, and at least one water-splifting ion exchange membrane between the electrodes, the method comprising:
(a) in a deionization mode, flowing fluid into the first orifice of the cell while maintaining a current between the electrodes in the cell to form treated fluid which is passed out of the second orifice of the cell; and
(b) in a regeneration mode, flowing fluid into the second orifice of the cell while maintaining a current between the electrodes of the cell to regenerate the cell.

55. A method according to claim 54 wherein (a) or (b) comprises flowing into the first orifice of the cell, a fluid comprising a solution that includes water.

56. A method according to claim 54 wherein (b) comprises flowing fluid comprising treated fluid into the second orifice.

57. A method according to claim 56 further comprising a second electrochemical cell having orifices, a pair of electrodes, and a water-splitling ion exchange membrane between the electrodes and wherein the method comprises forming the treated fluid by flowing fluid into the second cell while maintaining a current in the second cell to form the treated fluid.

58. A method according to claim 54 comprising operating a valve to direct the flow of fluid.

59. A method according to claim 58 wherein the valve comprises (i) a plurality of ports which are connected to the orifices of the cell, (ii) a movable element capable of moving between positions in which the ports are aligned to, or blocked from, one another, and (iii) a motor to move the movable element, and wherein the method comprises operating the motor to move the movable element to positions in which the ports are aligned or blocked to control the flow of fluid.

60. A fluid treatment method conducted in first and second electrochemical cells, each electrochemical cell comprising a first orifice to receive fluid for deionization and a second orifice to expel deionized fluid, a pair of electrodes, and a water-splitting ion exchange membrane between the electrodes, the method comprising:
(a) forming deionized fluid in the first cell by flowing fluid into the first orifice of the first cell while maintaining a current between the electrodes of the first cell to form deionized fluid which is passed out of the second orifice of the first cell; and
(b) regenerating the second cell by flowing the deionized fluid from the second orifice of the first cell into the second orifice of the second cell while maintaining a current between the electrodes of the second cell to regenerate the second cell.
